(19) United States
(12) Patent Application Publication
(10) Pub. No.: US 2025/0137196 A1
(43) Pub. Date: May 1, 2025

(54) HYDROPHOBIC COATING AND METHOD OF APPLICATION TO SUBSTRATES

(71) Applicant: Green Theme Technologies Inc., Rio Rancho, NM (US)

(72) Inventor: Xia Zhao, Malvern, PA (US)

(21) Appl. No.: 18/923,495

(22) Filed: Oct. 22, 2024

Related U.S. Application Data
(60) Provisional application No. 63/593,162, filed on Oct. 25, 2023.

(51) Int. Cl. D06N 3/12; C08G 77/04; C08G 77/08; C09D 4/00; C09D 5/00; C09D 183/04

(52) U.S. Cl. CPC D06N 3/128; C08G 77/045; C08G 77/08; C09D 4/00; C09D 5/00; C09D 183/04; C08G 2150/00; D06N 3/123; D06N 3/125; D06N 2209/141; D06N 2211/106; D10B 2331/02; D10B 2331/04; D10B 2401/021; D10B 2501/043

(57) ABSTRACT

The invention relates to a method for treating a textile to inhibit wicking and/or provide durable water repellency. The method includes applying one or more first coating solutions to at least one surface of a material substrate and curing the first coating solution under ambient atmospheric pressure to form one or more water-repellent layers on the material substrate. The first coating solution and water-repellent layer are fluorine free and water free. The first coating solution includes one or more first chemical components having a Si—H group, one or more second chemical components having an alkene group, and one or more catalyst agents that cause a specific chemical reaction between the Si—H group and alkene group to link the first chemical component to the second chemical component.

### CROSS-REFERENCE TO RELATED APPLICATIONS

This patent application claims priority to U.S. Provisional Application No. 63/593,162 filed Oct. 25, 2023, which provisional is incorporated herein by specific reference in its entirety.

### BACKGROUND

### Technical Field

The invention pertains to a method for treating textiles to inhibit wicking by applying and curing a fluorine-free and water-free precursor coating composition to form a hydrophobic coating on the textiles.

### Related Art

Textiles are an integral part of our daily lives, and used in a variety of applications, such as clothing, home furnishings, and industrial products. However, one of the common issues faced with textiles is their tendency to absorb and retain moisture, a phenomenon known as wicking. This can lead to a variety of problems, including discomfort for the wearer in the case of clothing, or potential damage and degradation of the textile material over time.

Wicking refers to the process by which moisture travels through a material, often by capillary action, moving from one surface to another. In footwear, wicking can become a significant issue because it draws water, sweat, or other liquids into the inner layers of the shoe, leading to discomfort, odor, and even degradation of materials over time. For example, if the outer surface of a shoe becomes wet, moisture can migrate through seams or fabric linings, making the inside damp and creating an environment conducive to bacterial and fungal growth. This not only compromises the user's comfort but can also reduce the lifespan of the footwear. Traditionally, various methods have been employed to reduce the wicking properties of textiles. These often involve the application of a hydrophobic (water-repelling) coating to the textile surface. To inhibit wicking of textiles, manufacturers often use water-repellent treatments, seam-sealing tapes, or hydrophobic materials. One effective example is incorporating expanded polytetrafluoroethylene (ePTFE) membranes, which block water from penetrating the shoe while allowing vapor to escape, ensuring the footwear stays breathable and dry from both external and internal moisture sources. However, these coatings often contain fluorine or other potentially harmful substances, which raises environmental and health concerns. Furthermore, the application of these coatings often requires the use of water or other solvents, which can introduce additional complications, such as the need for specialized equipment or processes to clean the water, and potential environmental impact due to the disposal of used solvents.

Other strategies to inhibit moisture in footwear and other textiles include using tightly woven fabrics, applying durable water-repellent (DWR) coatings, or designing shoes or other textile articles of manufacture with fewer seams and overlaps to minimize pathways for moisture migration. DWR is a coating applied to fabrics to make them water-resistant by causing water to bead up and roll off the surface rather than soak in. While DWR does not make a material entirely waterproof (like a membrane such as ePTFE), it enhances the performance of water-resistant garments and footwear by preventing the outer layers from becoming saturated. This helps maintain breathability, as a soaked outer layer can trap moisture inside, making the wearer feel wet and uncomfortable. DWR treatments lower the surface tension of the fabric, creating a hydrophobic surface. When water contacts the treated surface, it forms droplets that slide off instead of being absorbed. In shoes, DWR coatings are often applied to nylon, polyester, or leather uppers to prevent them from becoming waterlogged. This is especially useful in outdoor or athletic footwear to keep the shoes lightweight and dry in wet conditions. However, most DWR coatings fail to provide wicking resistance, especially failing to provide wicking resistance in footwear applications. Previously, materials that have generally been used as hydrophobic coatings are aqueous emulsions that include fluorinated compounds, such as per- and polyfluoroalkyl substances (PFAS), such as ePTFE. Unfortunately, PFAS and other fluorinated compounds may lead to adverse health outcomes. Furthermore, such hydrophobic coatings tend to involve adding water and/or pressure and/or removing oxygen to effectively be applied to a substrate. Thus, there is a need for a fluorine-free hydrophobic coating composition that can be applied to substrates, such as textiles, without the addition of water or pressure and without the removal of oxygen.

Therefore, there is a need for an improved method for treating textiles to inhibit wicking that addresses these issues. Such a method would ideally be environmentally friendly by not contaminating water or requiring the use of harmful substances or large amounts of solvents.

### SUMMARY

In some embodiments, a method for treating a textile to inhibit wicking is provided. The method can include: applying a precursor coating composition to at least one surface of a textile; and curing the precursor coating composition under ambient atmospheric pressure to the at least one surface of the textile to form a hydrophobic coating on the textile. The precursor coating composition and hydrophobic coating are fluorine free and the precursor coating composition and hydrophobic coating are water free. The precursor coating composition includes: A. a first chemical moiety having a Si—H group; B. a second chemical moiety having an alkene group; and C. a metallic catalyst that causes a hydrosilylation reaction between the Si—H group and alkene group to link the first chemical moiety to the second chemical moiety. The first chemical moiety and second chemical moiety are on separate molecules (chemicals) or on a common molecule (chemical).

In some embodiments, the precursor coating composition includes: a first reagent having the at least one Si—H group; a second reagent having the at least one alkene group; and an organometallic catalyst. The first reagent can include silanes, hydrogen siloxanes, or polyalkylhydrogensiloxanes. The second reagent can include a vinyl group, an olefin, an acrylate silane, an acrylate siloxane, dienes, or polydienes. In some aspects, the second reagent also includes at least one of a hydrocarbon group, an acrylate group, a siloxane group, a silane group, or combinations thereof.

Accordingly, the coating compositions provided herein can inhibit wicking for water. The coating can then be used in footwear to inhibit wicking. In some cases, zero wicking or nearly no wicking can be observed with textiles (e.g., shoes) treated with the coating compositions described herein. Accordingly, the present coating compositions a fluorine free chemical hydrophobic composite for treating finished textiles to achieve substantially no-wicking for footwear. Additionally, the coating compositions can be used to provide a durable water repellency (DWR) coating for other textiles, such as clothing.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and following information as well as other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 illustrates a method for treating a textile to inhibit wicking.

FIG. 2 illustrates two different embodiments of systems for preparing the precursor coating composition.

FIG. 3 illustrates examples of hydrosilylation reactions.

FIG. 4 illustrates examples of catalysts.

The elements and components in the figures can be arranged in accordance with at least one of the embodiments described herein, and which arrangement may be modified in accordance with the disclosure provided herein by one of ordinary skill in the art.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Generally, the present technology relates to compounds and/or materials for use in forming a hydrophobic coating on a substrate, such as a textile material. Hydrophobic coatings are applied to various substrates to protect them from moisture and/or waterproof them. For example, hydrophobic coatings are used on textiles to create water-repellant/waterproof apparel, such as shirts, pants, coats, hats, and footwear. Low- to no-wick and/or durable water repellency (DWR) resulting from applying hydrophobic coatings to substrates is used extensively in performance outerwear apparel, such as in raincoats and water-proof footwear. Hydrophobic coatings are applied in a wide variety of settings in which it is important to prevent water or other liquids from wetting or seeping through a substrate.

In accordance with embodiments of the invention, a method is provided for treating a material substrate to inhibit wicking. The method involves applying one or more first coating solutions to at least one surface of a material substrate and curing the first coating solution under ambient atmospheric pressure to form one or more water-repellent layers on the material substrate. The first coating solution and resulting cured water-repellent layer are fluorine free and water free. The first coating solution includes one or more first chemical components having a Si—H group, one or more second chemical components having an alkene group (e.g., vinyl group, olefin, acrylate silane, acrylate siloxane, acrylates, dienes, polydienes, or the like), and one or more catalyst agents that cause a specific chemical reaction between the Si—H group and alkene group to link the first chemical component to the second chemical component. The first chemical component and second chemical component can be on separate chemicals or on a common chemical. The method can further include preparing the first coating solution in various ways, applying the first coating solution to the material substrate after forming the first coating solution, and curing at ambient or elevated temperature. While an elevated temperature can be used, it is noted that ambient temperatures are sufficient. The first coating solution can include one or more second reactants having at least one alkene group, one or more first reactants having at least one Si—H group, and one or more metal-based catalysts. The first reactants can be in a first reactive composition and the second reactants can be in a second reactive composition. The method can also include forming the first coating solution by mixing a ratio of the first reactive composition to the second reactive composition. The first coating solution can be applied to the at least one surface of the material substrate by various coating methods, such as spraying, brushing, dipping, rolling, and combinations thereof.

Described herein are methods of creating hydrophobic coatings, comprising combining a second compound comprising at least one hydrocarbon and at least one alkene group, a first compound comprising at least one Si—H bond, and an organometallic compound that catalyzes hydrosilylation between the first compound and the second compound.

Described herein are methods of applying a hydrophobic coating to a substrate, comprising combining a first compound with a second compound to form the coating solution. The first compound includes at least one Si—H bond. The second compound is present in a range of about 0.5% to about 99.5% by weight. The second compound can include at least one hydrocarbon and at least one alkene group, wherein the second compound is present in a range of about 0.5% to about 99.5% by weight. Also included is an organometallic compound that catalyzes hydrosilylation between the first compound and the second compound to form a coating material. The method includes applying the coating material to a substrate; and curing the coating material into a coating.

Some embodiments include applying the coating to the substrate via direct coating, transfer coating, blade coating, blade-over-roll coating, blade-in-air coating, blade-over-blanket coating, reverse roll coating, roller coating, rotary screen coating, lick roll coating, gravure roll coating, extrusion coating, powder coating, spray coating, foam coating, and/or any other coating technique. Some embodiments include curing the coating at atmospheric pressure. Some embodiments include curing the coating without compressing the substrate to remove molecular oxygen from void spaces in the substrate. Some embodiments include applying a hydrophobic compound to a substrate without affirmatively adding water.

In an example embodiment, a method for treating a material substrate to inhibit wicking is disclosed. The method includes applying one or more first coating solutions to at least one surface of a material substrate and curing the first coating solution under ambient atmospheric pressure to the at least one surface of the material substrate to form one or more water-repellent layers on the material substrate. In this example embodiment, the first coating solution and water-repellent layer are fluorine free and water free. The first coating solution includes one or more first chemical components having a Si—H group, one or more second chemical components having an alkene group (e.g., vinyl group, olefin, acrylate silane, acrylate siloxane, acrylates, dienes, polydienes, or the like), and one or more catalyst agents that cause a specific hydrosilylation chemical reaction between the Si—H group and the alkene group to link the first chemical component to the second chemical component. The first chemical component and second chemical component can be on separate chemicals (e.g., molecules, polymers, etc.) or on a common chemical (e.g., polymer. The reaction can include a hydrosilylation reaction, also known as hydrosilation.

In another example embodiment, the method further includes preparing the first coating solution by preparing one or more first precursor solutions having one of the first chemical component or the second chemical component and combining the first precursor solution with one or more second precursor solutions that has the other of the first chemical component or second chemical component. In yet another example embodiment, the method further includes preparing the first coating solution by preparing one or more first precursor solutions having the first chemical component, preparing one or more second precursor solutions having the second component and the catalyst agent, and combining the first precursor solution with a second precursor solution into one or more reactive mixtures. In a further example embodiment, the method includes preparing the first coating solution by preparing one or more polymer-based precursor solutions having a dual-functional polymer with first monomer units having the first chemical components and second monomer units having the second chemical components.

In another example embodiment, the method includes preparing the second coating solution by introducing the catalyst agent to the second precursor solution, the reactive mixture of the first precursor solution and second precursor solution, or the polymer-based precursor solution with the dual-functional polymer. In yet another example embodiment, the method includes applying the first coating solution to the at least one surface of the material substrate after forming the first coating solution.

In a further example embodiment, the applying of the first coating solution to the at least one surface of the material substrate is within a time period after forming the first coating solution. The time period can be 1 hour or less, 45 minutes or less, 30 minutes or less, 15 minutes or less, 10 minutes or less, 5 minutes or less, 2 minutes or less, 1 minute or less, or immediately after the forming. In another example embodiment, the first coating solution is formed after mixing the first chemical component, second chemical component, and catalyst agent together for a mixing time of 1 hour or less, 45 minutes or less, 30 minutes or less, 15 minutes or less, 10 minutes or less, 5 minutes or less, 2 minutes or less, or 1 minute or less. In yet another example embodiment, the curing is at ambient temperature or at an elevated temperature that is below the melting point of the cured water-repellent layer.

In a further example embodiment, the first coating solution includes one or more first reactants having at least one Si—H group, one or more second reactants having at least one alkene (e.g., vinyl group, olefin, acrylate silane, acrylate siloxane, acrylates, dienes, polydienes, or the like) group, and one or more metal-based catalysts. The second reactant can also include at least one of a hydrocarbon chain, an acrylate group, a siloxane, silane, or combinations thereof. The first reactant can include hydrogen silanes and hydrogen siloxanes, which can include polymeric hydrogen siloxanes with at least one monomer having the Si—H group. The first reactants and second reactants are described in more detail herein.

In another example embodiment, the method further includes a tertiary reactant being a vinyl-functionalized siloxane (e.g., vinyl-functionalized silicone). In yet another example embodiment, the method includes forming the first coating solution by mixing the first reactant and the tertiary reactant into an first mixture, adding the metal-based catalyst to the first mixture, and mixing the first reactant (e.g., Si—H or composition thereof) with the first mixture to form the first coating solution. The tertiary reactant is described in more detail herein.

In another example embodiment, the method further includes a tertiary reactant being an alkene-functionalized siloxane (e.g., alkene-functionalized silicone). In yet another example embodiment, the method includes forming the first coating solution by mixing the first reactant and the tertiary reactant into an first mixture, adding the metal-based catalyst to the first mixture, and mixing the first reactant (e.g., Si—H or composition thereof) with the first mixture to form the first coating solution. The tertiary reactant is described in more detail herein.

In another example embodiment, the method further includes using a non-reactive silicone without a reactive functional group as part of the hydrophobic coating composition that is cured into the hydrophobic coating. Inert silicones that can be used in the precursor composition are generally well known.

In a further example embodiment, the method includes forming the first coating solution by mixing the first reactant and the tertiary reactant into an first mixture, adding the metal-based catalyst to the first mixture, mixing the first reactant with the non-reactive silicone into a second mixture, and mixing the first mixture with the second mixture to form the first coating solution.

In another example embodiment, the method includes forming the first coating solution by mixing a ratio of the first mixture to the second mixture, wherein the ratio ranges from 10: to 1:10, from 5:1 to 1:5, from 2:1 to 1:2; or about 1:1 or about 5:1.

In some aspects, one of the first reagent or second reagent is present in a range of about 20% to about 95% by weight, 50% to about 90% by weight, or 70% to 85% by weight, and the other of the first reagent or second reagent is present in a range of about 80% to about 5% by weight, 50% to about 10% by weight, or about 30% to about 15% by weight. In some aspects, one of the first reagent or the second reagent is present in a range of about 1% to about 50% by weight, 5% to about 30% by weight, or 10% to 20% by weight, and the other of the first reagent or second reagent is present in a range of about 99% to about 50% by weight, 95% to about 70% by weight, or about 90% to about 80% by weight.

In some embodiments, the first reagent and the second reagent are combined in about a 10-to-1 ratio, about a 5-to-1 ratio, about 2-to-1 ratio, or about a 1-to-1 ratio, or about a 1-to-10 ratio, about a 1-to-5 ratio, about a 1-to-2 ratio.

In some embodiments, the organometallic compound is present in a range of about 0.01 mL to 0.05 mL per 50 mL of combined first reagent and second reagent, or 0.017 mL to 0.02 mL per 50 mL of combined first reagent and second reagent. In some aspects, the organometallic compound is present in a range no more than 1%, 0.5%, or 0.1% by weight.

In some aspects, the curing of the coating material is at atmospheric pressure in a range of 750-775 mm Hg. In some aspects, the process of curing the coating material does not include compressing the substrate to remove molecular oxygen from void spaces in the textile. In some aspects, the process of curing the coating material is in the presence of atmospheric oxygen that is by mole fraction about 15-30% oxygen, about 18-25% oxygen, or about 19-22% oxygen. In some aspects, the process of curing the coating is at about room temperature, about 15-30° C., about 18-25° C., or about 20-22° C. In some aspects, the process of curing the coating material is at an elevated temperature about 30-200° C., about 50-150° C., about 75-130° C., or about 90-110° C.

In some embodiments, the process of forming the hydrophobic coating can be performed without water. In some aspects, no water is affirmatively added during the mixing, applying, or curing of the hydrophobic coating. In some aspects, only water in the air due to humidity is present during the mixing, applying, or curing of the hydrophobic coating.

In some embodiments, during the process of applying the coating material to a substrate, there is less than about 130 grams of water per cubic meter of air is present, less than about 84 grams of water per cubic meter of air is present, less than about 31 grams of water per cubic meter of air is present, or less than about 18 grams of water per cubic meter of air is present.

In some embodiments, the textile is a fibrous textile, nonwoven fabric, or filler material having interstitial spaces between intersecting fibers. In some aspects, the fibrous textile or nonwoven fabric includes knitted, woven, tufted, knotted, matted and/or entangled fibers. In some aspects, the textile includes a nylon, nylon blend, polyester, polyester blend, or combinations thereof.

In some embodiments, the precursor coating composition includes: a first reagent having at least one Si—H group; and a second reagent having at least one alkene (e.g., vinyl group, olefin, acrylate silane, acrylate siloxane, acrylates, dienes, polydienes, or the like); and an organometallic catalyst. In some aspects, the second reagent also includes at least one group of a hydrocarbon chain, an acrylate group, a siloxane, silane or combinations thereof. In some aspects, the first reagent includes hydrogen siloxanes. In some aspects, the precursor composition includes a third reactant being an alkene-functionalized siloxane (e.g., vinyl-functionalized silicone). In some aspects, the precursor composition includes an inert silicone without a reactive functional group.

In some embodiments, the second chemical moiety can have at least one alkene (e.g., vinyl group, olefin, acrylate silane, acrylate siloxane, acrylates, dienes, polydienes, or the like) group. However, second chemical moiety can have two or more alkene groups (e.g., two or more vinyl groups or a vinyl group and an internal alkene group, a diene, or the like), such as when a polymer. The second reagent includes at least one of a hydrocarbon group, an acrylate group, a siloxane group, silane group, or combinations thereof. Examples of the second reagents having the second chemical moiety are described herein.

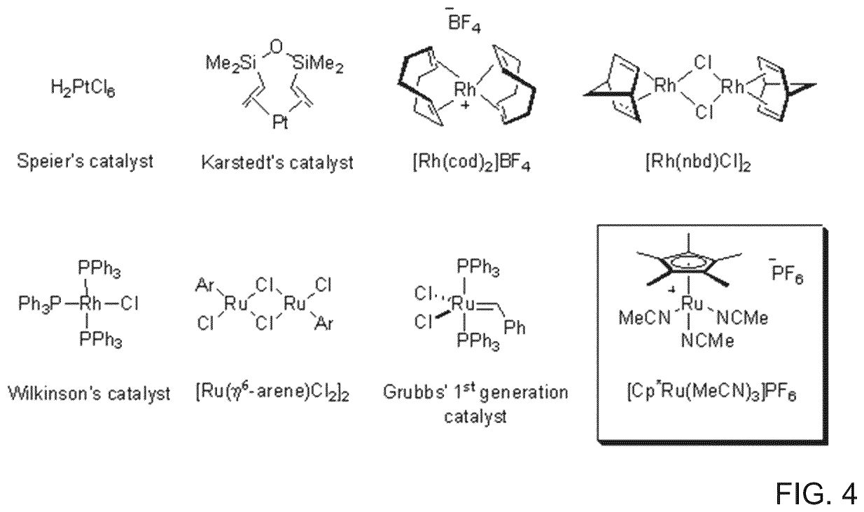

In some embodiments, the organometallic compound comprises one or more of the following: Speier's catalyst, Karstedt's catalyst, [Rh(cod)₂]BF₄, [Rh(nbd)Cl]2, Wilkinson's catalyst, Grubbs' 1^{st} generation catalyst, [Cp*Ru(MeCN)₃]PF₆, [Ru(benzene)Cl₂]², [Ru(p-cymene)Cl₂]², [Ru(η⁶-arene)Cl₂]², a platinum-based catalyst platinum-phosphine complexes, platinum-phosphite complexes, a palladium-based catalyst, and/or a rhodium-based catalyst. Examples of some of the catalysts are shown in FIG. 4.

In some embodiments, the first chemical moiety having the Si—H group can include other groups to provide performance to the curing composition and resulting hydrophobic coating. In some embodiments, the first chemical moiety can include at least one Si—H bond, such as a silane. In other embodiments, the first chemical moiety can include two or more Si—H bonds, such as a siloxane or an acrylate silane. The examples of the first reagent having the first chemical moiety are described herein.

In some embodiments, the first reagent that has the at least one Si—H bond is a silane, alkyl silane, dialkyl silane, trialkyl silane, aryl silane, aryl-alkyl silane, diaryl silane, triaryl silane diaryl alkyl silane, hydrogen siloxane, alkyl hydrogen siloxane copolymer, or other hydrogen siloxane copolymer. For example, the second reagent may be polymethylhydrosiloxane (PMHS).

In some embodiments, the first reagent can be a trialkyl silane, such as trimethylsilane (TMS); triethylsilane (TES); tripropylsilane; tributylsilane; triamylsilane; trihexylsilane; triheptylsilane; trinonylsilane; tri-2-ethylhexylsilane; or triisobutylsilane; or combinations thereof.

In some embodiments, the first reagent can be a phenylsilane, which includes phenyl-substituted silane with Si—H groups. Examples of the phenylsilanes include phenylsilane; diphenylsilane; triphenylsilane; tetraphenylsilane; methylphenylsilane; dimethylphenylsilane; trimethylphenylsilane; ethylphenylsilane; diethylphenylsilane; tiethylphenylsilane; or combinations thereof.

In some embodiments, the first reagent can be an alkoxysilane, such as trimethoxysilane (TMOS); triethoxysilane (TEOS); tripropoxysilane; tributoxysilane; triethoxyvinylsilane; triisopropoxysilane; methyldimethoxysilane; diethoxydimethylsilane; dimethoxydipropylsilane; methyltriethoxysilane; or combinations thereof.

In some embodiments, the first reagent can be a hydrosiloxane, which includes polymeric compounds with Si—H groups in the monomers, such as polymethylhydrosiloxane (PMHS). Some examples of the hydrosiloxanes can include poly(methylhydrosiloxane) (PMHS); poly(dimethylsiloxane-co-methylhydrosiloxane); poly(phenylmethylsiloxane-co-methylhydrosiloxane); poly(dimethylsiloxane-co-phenylhydrosiloxane); poly(methylphenylsiloxane-co-methylhydrosiloxane); poly(diphenylsiloxane-co-methylhydrosiloxane); poly(methylvinylsiloxane-co-methylhydrosiloxane); poly(phenylvinylsiloxane-co-methylhydrosiloxane); poly(phenylvinylsiloxane-co-phenylhydrosiloxane); poly(ethylhydrosiloxane); poly(ethylhydrosiloxane-co-diphenyl siloxane); poly(ethylhydrosiloxane-co-methylphenyl siloxane); poly(ethylhydrosiloxane-co-ethylphenyl siloxane); poly(propylhydrosiloxane); poly(propylhydrosiloxane-co-dimethyl siloxane); poly(propylhydrosiloxane-co-phenylmethyl siloxane); poly(propylhydrosiloxane-co-ethylmethyl siloxane); poly(propylhydrosiloxane-co-propylmethyl siloxane); poly(propylhydrosiloxane-co-phenylmethyl siloxane); poly(phenylhydrosiloxane); poly(phenylhydrosiloxane-co-dimethylsiloxane); poly(phenylhydrosiloxane-co-phenylmethylsiloxane); poly(phenylhydrosiloxane-co-ethylmethylsiloxane); or poly(phenylhydrosiloxane-co-methylhydrosiloxane); or combinations hereof.

In some embodiments, the second reagent includes the hydrocarbon chain, which comprises a chain of carbon atoms from about 1-50 carbon atoms, 2-35 carbon atoms, 3-30 carbon atoms, 4-25 carbon atoms, or 8-20 carbon atoms.

In some embodiments, the second reagent including the at least one alkene group includes a terminal vinyl group, at least two vinyl groups, or a vinyl group included on a monomer of a polymer. In some aspects, the at least one vinyl group is from a mono-acrylate, di-acrylate, tri-acrylate, or other multi-acrylate. The acrylate can include the hydrocarbon group, such as a hydrocarbon as described herein, such as one hydrocarbon group for a mono-acrylate, two hydrocarbon groups for di-acrylates, three hydrocarbon groups for tri-acrylates, and the like. Accordingly, the first reagent is a mono-acrylate, di-acrylate, tri-acrylate, or other multi-acrylate, and/or vinyl acetate, vinyl-functionalized silicone, diene, polydiene, and/or any reagent containing a hydrocarbon group and at least one alkene functional group.

In some embodiments, the second reagent including the at least one alkene group includes an internal alkene group, at least two internal alkene groups, or at least one internal alkene group and at least one vinyl group. For example, the alkene group can be included on a monomer of a polymer, such as a polydiene.

In some embodiments, the second reagent can be an alkene with a terminal vinyl group, such as ethylene; propylene; 2-methylpropene; 1-pentene; 1-hexene; 1-heptene; 1-octene; 1-nonene); 1-decene; butadiene, propylidene, pentadiene (e.g., other alkyls with terminal dienes) or combinations thereof. The second reagent with alkene groups can include any polymer with carbon-carbon double bonds, such as with hydrocarbon groups and/or siloxanes that have one terminal vinyl group. The second reagent can also include polydienes, such as polybutadiene.

In some embodiments, the second reagent can include vinyl acrylates, such as vinyl acetate; vinyl propionate; vinyl butyrate; vinyl acrylate; vinyl methacrylate; vinyl crotonate; vinyl isobutyrate; vinyl benzoate; vinyl 2-ethylhexanoate; vinyl caproate; or combinations thereof.

In some embodiments, the second reagent can include divinyl compounds having two vinyl groups, such as divinyl adipate; divinyl succinate; divinyl sebacate; divinyl phthalate; divinyl terephthalate; divinyl maleate; divinyl isophthalate; divinyl methylphosphonate; divinyl carbonate; divinyl ether; or combinations thereof. The divinyl groups can include any polymer, such as with hydrocarbon groups and/or siloxanes that have two terminal vinyl groups.

In some embodiments, the second reagent or third reagent can include vinyl-functionalized siloxanes, such as vinyl alkyl siloxanes and vinyl phenyl siloxanes or copolymers thereof. The alkyl group can be methyl, ethyl, propyl, butyl, and the like. For example, vinylmethylsiloxane, or copolymers thereof with other siloxane monomers, such as other alkyl or phenyl siloxane monomers described herein (e.g., dimethylsiloxane, phenylmethyl siloxane, diphenylsiloxane, etc.). Also, vinylphenylsiloxanes and copolymers thereof can be used. Additionally, the vinyl-functionalized siloxanes can include siloxanes with vinyl terminated monomers that, such as acryloxyalkylalkylsiloxane, which includes acryloxypropylmethylsiloxane, acryloxypropylethylsiloxane; acryloxyethylmethylsiloxane, acryloxydimethylsiloxane or copolymers thereof, or other combinations of alkyl groups on the silicon or between the silicon and vinyl group. Various other vinyl functionalized siloxanes, whether homopolymers or copolymers, may be used.

In some embodiments, the polymeric precursor composition has a bifunctional polymer with first monomers having the first chemical moieties with the Si—H group and second monomers having the second chemical moieties of the vinyl groups. Examples of the bifunctional polymers include poly(vinylmethoxysiloxane-co-methylhydrosiloxane); poly(vinylethoxysiloxane-co-phenylhydrosiloxane); poly(vinylchlorosiloxane-co-methylhydrosiloxane); poly(vinylmethylsiloxane-co-methylhydrosiloxane); poly(vinylethoxysiloxane-co-phenylhydrosiloxane); poly(vinylmethoxysiloxane-co-methylhydrosiloxane); poly(vinylisopropylsiloxane-co-phenylhydrosiloxane); poly(vinylphenylsiloxane-co-methylhydrosiloxane); poly(vinylphenylsiloxane-co-phenylhydrosiloxane); or combinations thereof.

In some embodiments, the second reagent includes olefins. The olefins can include ethylene, propylene, butene (1 or 2), isobutylene, pentene, hexene, octene, decene, isoprene, cyclohexene, dicyclopentadiene, and the like. The polymers with olefins can include polybutene-1, etheylene-propylene-diene polymer, or the like.

In some embodiments, the second reagent includes an acrylate silane, such as an alkylacryloxyalkyltrialkoxysilane, which includes 3-Methacryloxypropyltrimethoxysilane (CAS No. 2530-85-0). Notably, the methyl group lined to the alkene could be an ethyl, propyl, butyl, or the like. Also, the propyl group between the oxygen and silicon could be a methyl group, ethyl group, butyl group, pentyl group, or the like. Also, the methyl groups of the methoxys linked to the silicon can be ethyl groups, butyl group, pentyl group, or the like. The third reagent may also include the acrylate silane in some embodiments.

In some embodiments, the second reagent includes acrylate siloxanes, such as those compound having a vinyl group attached to a carbonyl group and a siloxane portion. Examples include methacrylate functionalized siloxanes or silicones. An example includes the structure in Formula D below, as described herein.

In some embodiments, the vinyl group of the second component is included in an acrylate group, such as those described herein. The acrylates can include methyl acrylates, ethyl acrylates, butyl acrylates, 2-ethylhexyl acrylates, methyl methacrylates, butyl methacrylates, 2-hydroxyethyl acrylates, hydroxypropyl acrylates, trimethylolpropane triacrylates, and silanes and siloxanes functionalized with the same.

In some embodiments, the diene is a polydiene, such as polybutadiene, polyisoprene, polychloroprene, polypentanamer, poly(1,2-butadiene), poly(1,4-hexadiene), poly(1,5-cyclooctadiene), or combinations thereof.

In some embodiments, the second reagent has the structure of Formula A, Formula B, Formula C, Formula A1, Formula B1, or Formula C1 wherein: R¹ is hydrogen or a hydrocarbon substituent that is substituted or unsubstituted; R² is a hydrocarbon substituent that is substituted or unsubstituted; R³ is a hydrocarbon substituent that is substituted or unsubstituted; Ra is a hydrocarbon substituent that is substituted or unsubstituted; and n is an integer greater than or equal to 0. The substituent on the hydrocarbon can be any substituent group defined herein or combination thereof.

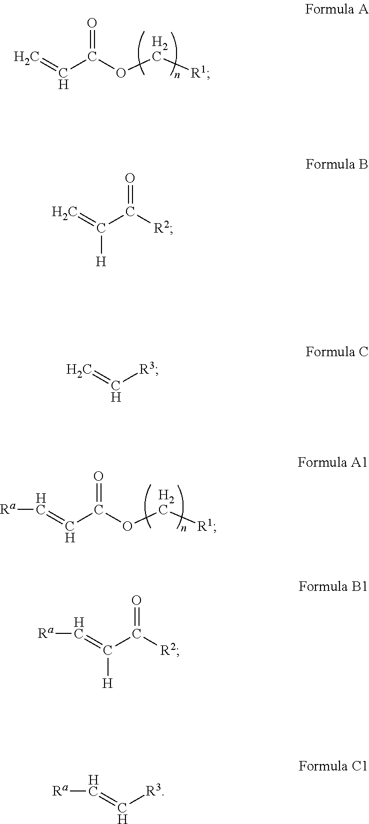

In some embodiments, the second reagent and/or third reagent has the structure of Formula D wherein: R⁴ is a hydrocarbon substituent that is substituted or unsubstituted; R⁵ is a hydrocarbon or aryl substituent that is substituted or unsubstituted; R⁶ is a hydrocarbon or aryl substituent that is substituted or unsubstituted; Y is a bond or a hydrocarbon linker that is substituted or unsubstituted; and m is an integer greater than or equal to 1; and n is an integer greater than or equal to 0.

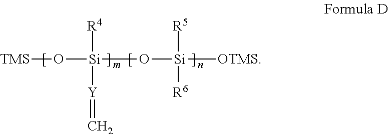

In some embodiments, the first reagent has the structure of Formula E, Formula F, or Formula G; wherein: R⁷, R¹, and R⁹ are each independently a hydrogen or a non-hydrogen substituent; R¹⁰ is a hydrocarbon substituent; R¹² and R¹³ are independently a non-hydrogen substituent; u is any integer greater than or equal to 1; and v is any integer greater than or equal to 0.

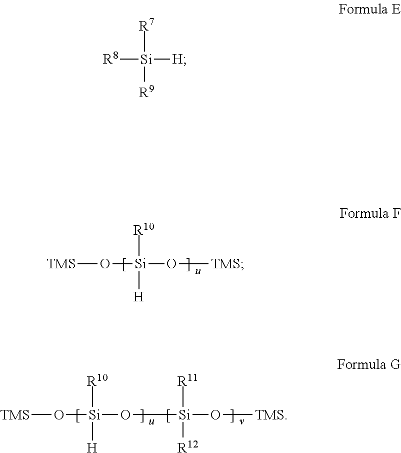

In some embodiments, the second or third component can have the structure of one of Formula H, Formula I, Formula J, or Formula K.

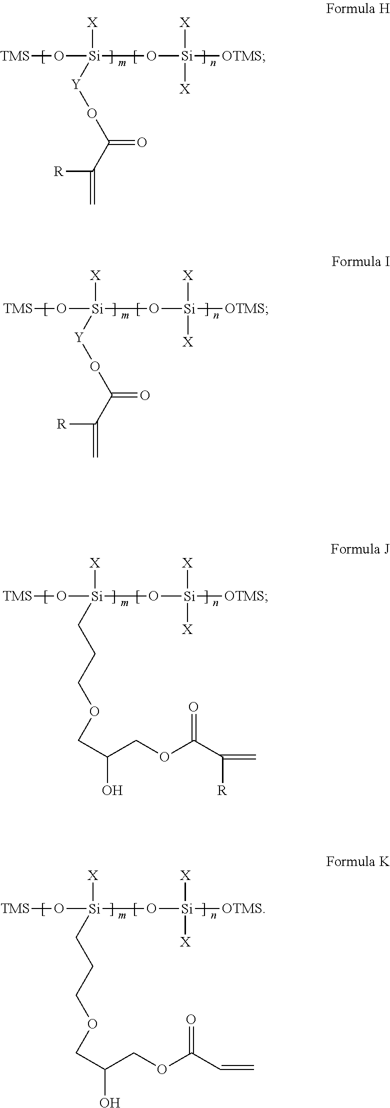

Formulae H, I, J, and K can include the m and n as defined below, and each X can independently be an alkyl group or other substituent or a polymerizable functional group. In the formulae, the n ranges from 1 to 50 (or from 10 to 20 or from 14 to 16) and the m ranges from 0.1 to 10 (or 0.5 to 5 or 0.9 to 3 or 1 to 3), such as m being 1 for each monomer. The molecular weight can range from 1,000 g/mol to 2,500 g/mol. The Y can be any linker, such as those described herein or otherwise known in the art. For example, the Y can be the linker shown in Formula J and Formula K. Also, the Y linker can include a C1-C10 alkyl, The R can be a substituent, such as an alkyl (e.g., methyl, ethyl, propyl, etc.).

In some embodiments, the Y linker can be a hydrocarbon chain with or without one or more hetero atoms, such as O, N, or S and with or without one or more substituents on the atoms of the chain. The Y linker may include straight aliphatics, branched aliphatics, cyclic aliphatics, substituted aliphatics, unsubstituted aliphatics, saturated aliphatics, unsaturated aliphatics, aromatics, polyaromatics, substituted aromatics, hetero-aromatics, ethers, amines, primary amines, secondary amines, tertiary amines, aliphatic amines, carbonyls, carboxyls, amides, esters, amino acids, peptides, polypeptides, derivatives thereof, substituted or unsubstituted, with or without hetero atoms, or combinations. In some aspects, the Y linker can include C1-C24 alkyl, C2-C24 alkenyl, C2-C24 alkynyl, C1-C24 alkyl esters, C6-C20 aryl, C7-C24 alkaryl, C7-C24 aralkyl, amino, mono- and di-(alkyl)-substituted amino, mono- and di-(aryl)-substituted amino, alkylamido, arylamido, imino, alkylimino, arylimino, nitro, nitroso, sulfo, sulfonato, alkylsulfanyl, arylsulfanyl, alkylsulfinyl, arylsulfinyl, alkylsulfonyl, arylsulfonyl, phosphono, phosphonato, phosphinato, phospho, phosphino, any with or without hetero atoms, any with or without a substituent, derivatives thereof, and combinations thereof.

In some embodiments, the substituent X or substituent on the linker can be a common substituent, such as hydrogen, alkyl, alkenyl, alkynyl, alkyl ester, aryl, alkaryl, aralkyl, halo, hydroxyl, sulfhydryl, alkoxy, alkenyloxy, alkynyloxy, aryloxy, acyl, alkylcarbonyl, arylcarbonyl, acyloxy, alkoxycarbonyl, aryloxycarbonyl, halocarbonyl, alkylcarbonato, arylcarbonato, carboxy, carboxylato, carbamoyl, mono-(alkyl)-substituted carbamoyl, di-(alkyl)-substituted carbamoyl, mono-substituted arylcarbamoyl, thiocarbamoyl, carbamido, cyano, isocyano, cyanato, isocyanato, isothiocyanato, azido, formyl, thioformyl, amino, mono- and di-(alkyl)-substituted amino, mono- and di-(aryl)-substituted amino, alkylamido, arylamido, imino, alkylimino, arylimino, nitro, nitroso, sulfo, sulfonato, alkylsulfanyl, arylsulfanyl, alkylsulfinyl, arylsulfinyl, alkylsulfonyl, arylsulfonyl, phosphono, phosphonato, phosphinato, phospho, phosphino, any with or without hetero atoms, any including straight chains, any including branches, and any including rings, derivatives thereof, and combinations thereof. For example, Formulae J and K show an alkyl ester linker that is substituted with a hydroxyl.

For Formulae H—K: when m is 1, the silicone monomer is monofunctional; when m is 2, the silicone monomer is di-functional; when, the m is 3, the monomer is tri-functional, and so on. Thus, the monomer may be multi-functional, which allows for crosslinking during the polymerization, such as when m is 2 or more.

In some embodiments, each non-hydrogen substituent of the formulae is selected from halogens, hydroxyls, alkoxys, straight aliphatics, branched aliphatics, cyclic aliphatics, substituted aliphatics, unsubstituted aliphatics, saturated aliphatics, unsaturated aliphatics, aromatics, polyaromatics, substituted aromatics, hetero-aromatics, amines, primary amines, secondary amines, tertiary amines, aliphatic amines, carbonyls, carboxyls, amides, esters, amino acids, peptides, polypeptides, derivatives thereof, substituted or unsubstituted, or combinations thereof.

In some embodiments, each hydrocarbon substituent is selected from alkoxys, straight aliphatics, branched aliphatics, cyclic aliphatics, substituted aliphatics, unsubstituted aliphatics, saturated aliphatics, unsaturated aliphatics, any substituted or unsubstituted, or combinations thereof.

In some embodiments, each non-hydrogen substituent is selected from C₁-C₂₄ alkyl, C₂-C₂₄ alkenyl, C₂-C₂₄ alkynyl, C₅-C₂₀ aryl, C₆-C₂₄ alkaryl, C₆-C₂₄ aralkyl, halo, hydroxyl, sulfhydryl, C₁-C₂₄ alkoxy, C₂-C₂₄ alkenyloxy, C₂-C₂₄ alkynyloxy, C₅-C₂₀ aryloxy, acyl (including C₂-C₂₄ alkylcarbonyl (—CO-alkyl) and C₆-C₂₀ arylcarbonyl (—CO-aryl)), acyloxy (—O-acyl), C₂-C₂₄ alkoxycarbonyl (—(CO)—O-alkyl), C₆-C₂₀ aryloxycarbonyl (—(CO)—O-aryl), halocarbonyl (—CO)—X where X is halo), C₂-C₂₄ alkylcarbonato (O—(CO)—O-alkyl), C₆-C₂₀ arylcarbonato (—O—(CO)—O-aryl), carboxy (—COOH), carboxylato (—COO⁻), carbamoyl (—(CO)—NH₂), mono-(C₁-C₂₄ alkyl)-substituted carbamoyl (—(CO)—NH(C₁-C₂₄ alkyl)), di-(C₁-C₂₄ alkyl)-substituted carbamoyl ((CO)—N(C₁-C₂₄ alkyl)₂), mono-substituted arylcarbamoyl (—(CO)—NH-aryl), di-substituted arylcarbamoyl (—(CO)—NH-aryl)₂, thiocarbamoyl (—(CS)—NH₂), mono-(C₁-C₂₄ alkyl)-substituted thiocarbamoyl (—(CS)—NH(C₁-C₂₄ alkyl)), di-(C₁-C₂₄ alkyl)- substituted thiocarbamoyl (—(CS)—N(C₁-C₂₄ alkyl)₂), mono-substituted arylthiocarbamoyl (—(CS)—NH-aryl), di-substituted arylthiocarbamoyl (—(CS)—NH-aryl)₂, carbamido (—NH—(CO)—NH₂),), mono-(C₁-C₂₄ alkyl)-substituted carbamido (NH(CO)—NH(C₁-C₂₄ alkyl)), di-(C₁-C₂₄ alkyl)-substituted carbamido (—NH(CO)—N(C₁-C₂₄alkyl)₂), mono-substituted aryl carbamido (—NH(CO)—NH-aryl), di-substituted aryl carbamido (—NH(CO)—N-(aryl)₂) cyano(—C≡N), isocyano (—N⁺≡C), cyanato (—O—C≡N), isocyanato (—O—N⁺≡C⁻), thiocyanato (—S—C≡N), isothiocyanato (—S—N⁺≡C⁻), azido (—N═N⁺═N⁻), formyl (—(CO)—H), thioformyl (—(CS)—H), amino (—NH₂), mono- and di-(C₁-C₂₄ alkyl)-substituted amino, mono- and di-(C₆-C₂₀ aryl)-substituted amino, C₂-C₂₄ alkylamido (—NH—(CO)-alkyl), C₅-C₂₀ arylamido (—NH—(CO)-aryl), imino (—CR═NH where R is hydrogen, C₁-C₂₄ alkyl, C₅-C₂₀ aryl, C₆-C₂₄ alkaryl, C₆-C₂₄ aralkyl, etc.), alkylimino (—CR═N(alkyl), where R=hydrogen, C₁-C₂₄ alkyl, aryl, alkaryl, aralkyl, etc.), arylimino (—CR═N(aryl), where R=hydrogen, alkyl, aryl, alkaryl, etc.), nitro (—NO₂), nitroso (—NO), sulfonic acid (—SO₂—OH), sulfonato (—SO₂—O⁻), C₁-C₂₄ alkylsulfanyl (—S-alkyl; also termed “alkylthio”), C₅-C₂₀ arylsulfanyl (—S-aryl; also termed “arylthio”), C₁-C₂₄ alkylsulfinyl (—(SO)-alkyl), C₅-C₂₀ arylsulfinyl (—(SO)-aryl), C₁-C₂₄ alkylsulfonyl (—SO₂-alkyl), C₅-C₂₀ arylsulfonyl (—SO₂-aryl), phosphono (—P(O)(OH)₂), phosphonato (—P(O)(O⁻)₂), phosphinato (—P(O)(O—)), phospho (—PO₂), phosphino (—PH₂), any with or without hetero atoms (e.g., N, O, P, S, or other) where the hetero atoms can be substituted (e.g., hetero atom substituted for carbon in chain or ring) for the carbons or in addition thereto (e.g., hetero atom added to carbon chain or ring) swapped, any including straight chains, any including branches, and any inducing rings, derivatives thereof, and combinations thereof.

In some embodiments, each hydrocarbon substituent is selected from C₁-C₂₄ alkyl, C₂-C₂₄ alkenyl, C₂-C₂₄ alkynyl, C₅-C₂₀ aryl, C₆-C₂₄ alkaryl, C₆-C₂₄ aralkyl, C₁-C₂₄ alkoxy, C₂-C₂₄ alkenyloxy, C₂-C₂₄ alkynyloxy, C₅-C₂₀ aryloxy, acyl (including C₂-C₂₄ alkylcarbonyl (—CO-alkyl) and C₆-C₂₀ arylcarbonyl (—CO-aryl)), acyloxy (—O-acyl), C₂-C₂₄ alkoxycarbonyl (—(CO)—O-alkyl), C₆-C₂₀ aryloxycarbonyl (—(CO)—O-aryl), any including straight chains, any including branches, and any inducing rings, derivatives thereof, and combinations thereof.

In some embodiments, the precursor coating composition further comprising a plasticizer, stabilizer, lubricant, inhibitor, colorant, and/or non-aqueous solvent.

In some aspects, the applying of the coating material to the textile is done via direct coating, transfer coating, blade coating, blade-over-roll coating, blade-in-air coating, blade-over-blanket coating, reverse roll coating, roller coating, rotary screen coating, lick roll coating, gravure roll coating, extrusion coating, powder coating, spray coating, foam coating, and/or any other coating technique. In a further example embodiment, the first coating solution is applied to the at least one surface of the material substrate by a method selected from the group consisting of spraying, brushing, dipping, rolling, and combinations thereof.

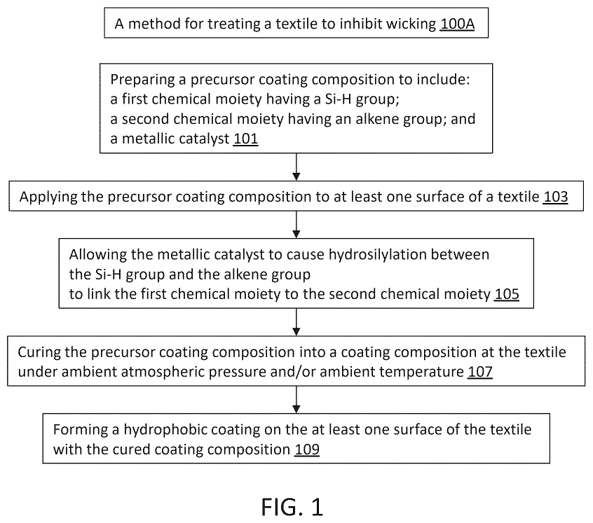

FIG. 1 illustrates, in a flowchart, operations for treating a textile to inhibit wicking in accordance with certain embodiments. A method of treating a textile is provided (block 100A) for preparing a precursor coating composition to include a first chemical moiety having a Si—H group; a second chemical moiety having an alkene group; and a metallic catalyst at block 101. The method includes applying the precursor coating composition to at least one surface of a textile at block 103. The method includes allowing the metallic catalyst to cause hydrosilylation between the Si—H group and the alkene group to link the first chemical moiety to the second chemical moiety at block 105. The method includes curing the precursor coating composition into a coating composition at the textile under ambient atmospheric pressure and/or ambient temperature at block 107. The method can include forming a hydrophobic coating on the at least one surface of the textile with the cured coating composition at block 109.

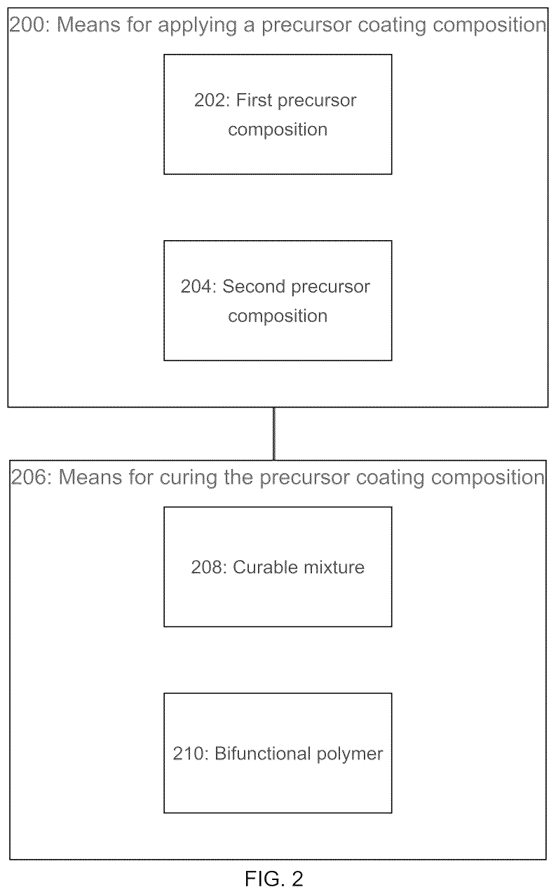

FIG. 2 illustrates, in a block diagram, a system for treating a textile to inhibit wicking in accordance with certain embodiments. The system includes means for applying a precursor coating composition (200) to at least one surface of a textile and means for curing the precursor coating composition (206) under ambient atmospheric pressure to the at least one surface of the textile to form a hydrophobic coating on the textile. The precursor coating composition is prepared by preparing a first precursor composition 202 having one of the first chemical moiety (e.g., Si—H group) or the second chemical moiety (e.g., vinyl group) and combining the first precursor composition with a second precursor composition 204 that has the other of the first chemical moiety or second chemical moiety. The precursor coating composition is a curable mixture 208 when the first precursor and second precursor are mixed with the appropriate metal catalyst. The precursor coating composition can also be prepared by preparing a bifunctional polymer 210 having first monomers having the first chemical moieties and second monomers having the second chemical moieties.

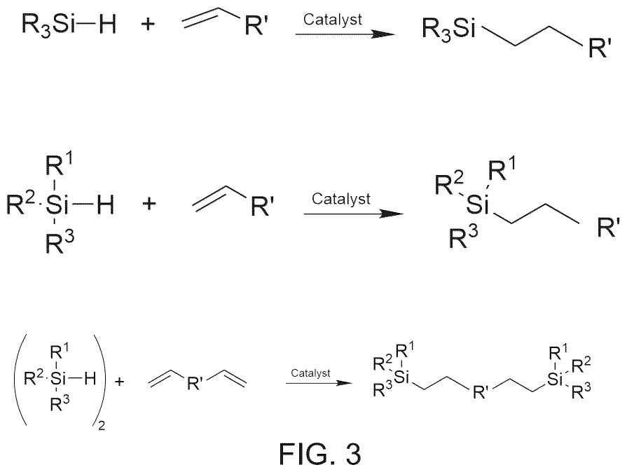

The hydrosilylation reaction can be performed as shown in FIG. 3. As shown, the molecule with the Si—H bond can include R groups that are the same, or different as in R¹, R², and R³, where different reaction schemes are shown with second reagents with one or two vinyl groups.

### EXAMPLES

A fluorine free chemical hydrophobic composite is provided for treating finished textiles to achieve no-wicking for footwear and durable water repellency (DWR) for apparel, which comprises 0.5%-99.5% of a compound A containing Si—H bonds, 0.5%-99.5% of a compound B containing at least one vinyl group, and a metal catalyst for hydrosilylation reactions. This is a water free process, and this coating can be cured under the atmosphere. The textiles can be fabrics, such as synthetic or natural fabrics and/or their blends such as Nylon/Nylon blends, polyester/polyester blends, or the like. The coating can be formed by applying the coating composition on to at least one side of the fabric and curing at either room temperature or an elevated temperature in the normal atmospheric pressure and atmospheric gas.

The water-free coating described herein can be applied to textiles to achieve low- to no-wick and/or DWR. Low- to no-wick is a crucial performance for show fabrics and DWR is a crucial performance for apparel outerwear.

### Example 1

### Coating Composition:

Part I preparation: Mix 35% of stearyl acrylate and 65% of vinyl siloxane. Add 1 drop of 5% Karstedt's catalyst in 50 mL of the mixture.

Part II preparation: Mix 60% of polymethylhydrogensiloxane and 40% of polydimethylsiloxane.

### Coating Preparation:

Blend Part I and II in 5 to 1 ratio before use.

### Coating Process:

The coating was applied on one side or both sides of the fabrics on a gravure coater.

### Curing Process:

Fabrics were left in the atmosphere for curing without additional heating. As an alternative, the fabrics can be heated at a higher temperature like 100° C. to 110° C. for a quick curing.

### Wicking Test:

Nike G018—Standard test method for water wicking.

Table 1 shows the testing wicking test results of seven footwear fabrics before and after the treatment. Those fabrics are made of different materials in various constructions.

TABLE 1
Wicking Results for Footwear Fabrics

| | | WICKING | WICKING |
|---|---|---|---|
| | | IN LENTH | IN WIDTH |
| FABRIC | UNTREATED | (2 HRS), | (2 HRS), |
| MATERIAL | VS TREATED | MM | MM |
| 100% Mesh | Untreated | 65 | 65 |
| Fabric | Treated | 0 | 0 |
| 100% CD PET | Untreated | 65 | 65 |
| | Treated | 0 | 0 |
| 60% CD PET + | Untreated | 65 | 65 |
| 40% PET Warp | Treated | 0 | 0 |
| Knit | | | |
| 92% CD PET + | Untreated | 65 | 65 |
| 8% Spandex | Treated | 0 | 0 |
| Warp: 52% Nylon | Untreated | 65 | 65 |
| Weft: 48% Nylon | Treated | 0 | 0 |
| 85% Nylon + | Untreated | 65 | 65 |
| 15% Spandex | Treated | 1 | 1 |
| 100% PET Spacer | Untreated | 65 | 65 |
| | Treated | 1 | 0 |

Warp threads run lengthwise in a fabric. Weft or filling threads run across the width of a fabric at right angles to the warp. Since monofilament fabrics are produced with equal yarn diameters and equal thread counts in both the warp and weft directions, the mesh opening is square.

### Example 2

The same coating has been applied on apparel fabrics in the same process as Example 1. Spray test was performed for wash durability. The water repellency spray test was the AATCC TM-022. Three fabrics were treated, and their wash durability spray rating results up to 100× washes are shown in Table 2.

TABLE 2
Water Repellency of Treated Apparel Fabrics

| | 100% PET, | | 100% |
|---|---|---|---|
| SPRAY RATING | PREPARED- | 100% PET, | NYLON, |
| AFTER WASHES | TO-DYE | DYED | DYED |
| 0X | 100 | 90 | 90 |
| 5X | 100 | 80 | 90 |
| 10X | 100 | 90 | 100 |
| 20X | 100 | 100 | 100 |
| 30X | 100 | 100 | 100 |
| 40X | 100 | 100 | 100 |
| 50X | 100 | 100 | 100 |
| 60X | 100 | 100 | 100 |
| 70X | 100 | 100 | 90 |
| 80X | 100 | 100 | 70 |
| 90X | 100 | 100 | 100 |
| 100X | 100 | 80 | 100 |

### EMBODIMENTS

Embodiment 1. A method for treating a textile to inhibit wicking and/or provide durable water repellency, comprising: applying a precursor coating composition to at least one surface of a textile; and curing the precursor coating composition under ambient atmospheric pressure to the at least one surface of the textile to form a hydrophobic coating on the textile. The precursor coating composition and hydrophobic coating are fluorine free. The precursor coating composition and hydrophobic coating are water free. The precursor coating composition includes: A. a first chemical moiety having a Si—H group; B. a second chemical moiety having an alkene group; and C. a metallic catalyst that causes a hydrosilylation reaction between the Si—H group and alkene group to link the first chemical moiety to the second chemical moiety. The first chemical moiety and second chemical moiety are on separate chemicals or on a common chemical.

Embodiment 2. The method of one of the embodiments, comprising preparing the precursor coating composition by: preparing a first precursor composition having one of the first chemical moiety or the second chemical moiety; and combining the first precursor composition with a second precursor composition that has the other of the first chemical moiety or second chemical moiety.

Embodiment 3. The method of one of the embodiments, comprising preparing the precursor coating composition by: preparing a first precursor composition having the first chemical moiety; preparing a second precursor composition having the second moiety and the metallic catalyst; and combining the first precursor composition with a second precursor composition into a curable mixture.

Embodiment 4. The method of one of the embodiments, comprising preparing the precursor coating composition by: preparing a polymeric precursor composition having a bifunctional polymer with first monomers having the first chemical moieties and second monomers having the second chemical moieties.

Embodiment 5. The method of one of the embodiments, comprising preparing the precursor coating composition by introducing the metallic catalyst to: the first precursor composition; the second precursor composition; the curable mixture of the first precursor composition and second precursor composition; or the polymeric precursor composition with the bifunctional polymer.

Embodiment 6. The method of one of the embodiments, comprising applying the precursor coating composition to the at least one surface of the textile after forming the precursor coating composition.

Embodiment 7. The method of one of the embodiments, wherein the applying of the precursor coating composition to the at least one surface of the textile with within a time period after forming the precursor coating composition, wherein the time period is 1 hour or less, 45 minutes or less, 30 minutes or less, 15 minutes or less, 10 minutes or less, 5 minutes or less, 2 minutes or less, 1 minute or less, or immediately after the forming.

Embodiment 8. The method of one of the embodiments, wherein the precursor coating composition is formed after mixing the first chemical moiety, second chemical moiety, and metallic catalyst together for a mixing time of 1 hour or less, 45 minutes or less, 30 minutes or less, 15 minutes or less, 10 minutes or less, 5 minutes or less, 2 minutes or less, or 1 minute or less.

Embodiment 9. The method of one of the embodiments, wherein the curing is at one of: ambient temperature of 20° C.-25° C.; or an elevated temperature over 25° C. that is below the melting point of the cured hydrophobic coating. In some aspects, the curing can be performed without affirmatively introducing any heat or otherwise causing the temperature to increase.

Embodiment 10. The method of one of the embodiments, wherein the precursor coating composition includes: a first reagent having at least one Si—H group; a second reagent having at least one vinyl group; and an organometallic catalyst.

Embodiment 11. The method of one of the embodiments, wherein the second reagent includes at least one of a hydrocarbon group, an acrylate group, a siloxane, or combinations thereof.

Embodiment 12. The method of one of the embodiments, wherein the first reagent includes hydrogen siloxanes.

Embodiment 13. The method of one of the embodiments, further comprising a third reactant being a vinyl-functionalized siloxane or vinyl-functionalized silicone.

Embodiment 14. The method of one of the embodiments, further comprising an inert silicone without a reactive functional group.

Embodiment 15. The method of one of the embodiments, comprising forming the precursor coating composition by: mixing the second reagent and the third reagent into a first mixture; adding the organometallic catalyst to the first mixture; and mixing the first reagent with the first mixture to form the precursor coating composition.

Embodiment 16. The method of one of the embodiments, comprising forming the precursor coating composition by: mixing the second reagent and the third reagent into a first mixture; adding the organometallic catalyst to the first mixture; mixing the first reagent with the inert silicone into a second mixture; and mixing the first mixture with the second mixture to form the precursor coating composition.

Embodiment 17. The method of one of the embodiments, comprising forming the precursor coating composition by mixing a ratio of the first mixture to the second mixture, wherein the ratio ranges from 10: to 1:10, from 5:1 to 1:5, from 2:1 to 1:2; or about 1:1 or about 5:1.

Embodiment 18. The method of one of the embodiments, comprising: combining the first reagent with the second reagent and metal catalyst, wherein: the first reagent includes at least one Si—H group, wherein the first reagent is present in a range of about 0.5% to about 99.5% by weight; the second reagent includes at least one alkene group and one hydrocarbon group, wherein the second reagent is present in a range of about 0.5% to about 99.5% by weight; and the metal catalyst is an organometallic compound that catalyzes hydrosilylation between the first reagent and the second reagent to form a coating material.

Embodiment 19. The method of one of the embodiments, wherein one of the first reagent or second reagent is present in a range of about 20% to about 95% by weight, 50% to about 90% by weight, or 70% to 85% by weight, and the other of the first reagent or second reagent is present in a range of about 80% to about 5% by weight, 50% to about 10% by weight, or about 30% to about 15% by weight.

Embodiment 20. The method of one of the embodiments, wherein one of the first reagent or the second reagent is present in a range of about 1% to about 50% by weight, 5% to about 30% by weight, or 10% to 20% by weight, and the other of the first reagent or second reagent is present in a range of about 99% to about 50% by weight, 95% to about 70% by weight, or about 90% to about 80% by weight.

Embodiment 21. The method of one of the embodiments, wherein the first reagent and the second reagent are combined in about a 10-to-1 ratio, about a 5-to-1 ratio, about 2-to-1 ratio, or about a 1-to-1 ratio, or about a 1-to-10 ratio, about a 1-to-5 ratio, about a 1-to-2 ratio.

Embodiment 22. The method of one of the embodiments, wherein the organometallic compound is present in a range of about 0.01 mL to 0.05 mL per 50 mL of combined first reagent and second reagent, or 0.017 mL to 0.02 mL per 50 mL of combined first reagent and second reagent.

Embodiment 23. The method of one of the embodiments, wherein the organometallic compound is present in a range no more than 1%, 0.5%, or 0.1% by weight.

Embodiment 24. The method of one of the embodiments, wherein applying the coating material to the textile is done via direct coating, transfer coating, blade coating, blade-over-roll coating, blade-in-air coating, blade-over-blanket coating, reverse roll coating, roller coating, rotary screen coating, lick roll coating, gravure roll coating, extrusion coating, powder coating, spray coating, foam coating, and/or any other coating technique.

Embodiment 25. The method of one of the embodiments, wherein curing the coating material is at atmospheric pressure range of 750-775 mm Hg. In some aspects, the method is performed with affirmatively introducing a pressure increase or causing the pressure to increase.

Embodiment 26. The method of one of the embodiments, wherein curing the coating material does not include compressing the substrate to remove molecular oxygen from void spaces in the textile.

Embodiment 27. The method of one of the embodiments, wherein curing the coating material is in the presence of atmospheric oxygen that is by mole fraction about 15-30% oxygen, about 18-25% oxygen, or about 19-2²% oxygen.

Embodiment 28. The method of one of the embodiments, wherein curing the coating is at about room temperature, about 15-30° C., about 18-25° C., or about 20-22° C.

Embodiment 29. The method of one of the embodiments, wherein curing the coating material is at an elevated temperature about 30-200° C., about 50-150° C., about 75-130° C., or about 90-110° C.

Embodiment 30. The method of one of the embodiments, wherein no water is affirmatively added during the mixing, applying, or curing.

Embodiment 31. The method of one of the embodiments, wherein only water in the air is present during the mixing, applying, or curing.

Embodiment 32. The method of one of the embodiments, wherein during applying the coating material to a substrate less than about 130 grams of water per cubic meter of air is present, less than about 84 grams of water per cubic meter of air is present, less than about 31 grams of water per cubic meter of air is present, or less than about 18 grams of water per cubic meter of air is present.

Embodiment 33. The method of one of the embodiments, wherein the textile is a fibrous textile, nonwoven fabric, or filler material having interstitial spaces between intersecting fibers.

Embodiment 34. The method of one of the embodiments, wherein the fibrous textile or nonwoven fabric includes knitted, woven, tufted, knotted, matted and/or entangled fibers.

Embodiment 35. The method of one of the embodiments, wherein the textile includes a nylon, nylon blend, polyester, polyester blend, or combinations thereof.

Embodiment 36. The method of one of the embodiments, wherein the precursor coating composition further comprises a plasticizer, stabilizer, lubricant, inhibitor, colorant, and/or non-aqueous solvent.

Embodiment 37. The method of one of the embodiments, wherein the precursor coating composition includes: a first reagent having the at least one Si—H group; a second reagent having the at least one alkene group; and an organometallic catalyst. The first reagent includes silanes, hydrogen siloxanes or polyalkylhydrogensiloxanes. The second reagent includes a vinyl group, an olefin, an acrylate silane, an acrylate siloxane, dienes, or polydienes.

Embodiment 38. The method of one of the embodiments, wherein the second reagent also includes at least one of a hydrocarbon group, an acrylate group, a siloxane group, a silane group, or combinations thereof.

Embodiment 39. The method of one of the embodiments, wherein: the first reagent that has the at least one Si—H bond is a silane, alkyl silane, dialkyl silane, alkoxy silane, trialkyl silane, aryl silane, phenyl silane, aryl-alkyl silane, diaryl silane, triaryl silane diaryl alkyl silane, hydrogen siloxane, alkyl hydrogen siloxane copolymer, or hydrogen siloxane copolymer. The method uses at least one of: the second reagent includes ethylene; propylene; 2-methylpropene; 1-pentene; 1-hexene; 1-heptene; 1-octene; 1-nonene); 1-decene; butadiene, propylidene, pentadiene, or combinations thereof: the second reagent includes vinyl acetate; vinyl propionate; vinyl butyrate; vinyl acrylate; vinyl methacrylate; vinyl crotonate; vinyl isobutyrate; vinyl benzoate; vinyl 2-ethylhexanoate; vinyl caproate; or combinations thereof, the second reagent includes adipate; divinyl succinate; divinyl sebacate; divinyl phthalate; divinyl terephthalate; divinyl maleate; divinyl isophthalate; divinyl methylphosphonate; divinyl carbonate; divinyl ether; or combinations thereof; vinyl-functionalized siloxanes, vinyl alkyl siloxanes, vinyl phenyl siloxanes, or copolymers thereof; the second reagent includes olefins selected from ethylene, propylene, butene, isobutylene, pentene, hexene, octene, decene, isoprene, cyclohexene, dicyclopentadiene, and combinations thereof, the second reagent includes an alkylacryloxyalkyltrialkoxysilane; the second reagent includes a polydiene selected from polybutadiene, polyisoprene, polychloroprene, polypentanamer, poly(1,2-butadiene), poly(1,4-hexadiene), poly(1,5-cyclooctadiene), or combinations thereof; or combinations thereof.

Embodiment 40. The method of one of the embodiments, wherein bifunctional polymers include poly(vinylmethoxysiloxane-co-methylhydrosiloxane); poly(vinylethoxysiloxane-co-phenylhydrosiloxane); poly(vinylchlorosiloxane-co-methylhydrosiloxane); poly(vinylmethylsiloxane-co-methylhydrosiloxane); poly(vinylethoxysiloxane-co-phenylhydrosiloxane); poly(vinylmethoxysiloxane-co-methylhydrosiloxane); poly(vinylisopropylsiloxane-co-phenylhydrosiloxane); poly(vinylphenylsiloxane-co-methylhydrosiloxane); poly(vinylphenylsiloxane-co-phenylhydrosiloxane); or combinations thereof.

### Definitions

By “substituted” as in “substituted alkyl,” “substituted aryl,” and the like, as alluded to in some of the definitions provided herein, is meant that in the alkyl, aryl, or other moiety, at least one hydrogen atom bound to a carbon (or other) atom is replaced with one or more non-hydrogen substituents.

In addition, the aforementioned functional groups may, if a particular group permits, be further substituted with one or more additional functional groups or with one or more hydrocarbyl moieties such as those specifically enumerated above. Analogously, the above-mentioned hydrocarbyl moieties may be further substituted with one or more functional groups or additional hydrocarbyl moieties such as those specifically enumerated.

When the term “substituted” appears prior to a list of possible substituted groups, it is intended that the term apply to every member of that group. For example, the phrase “substituted alkyl, alkenyl, and aryl” is to be interpreted as “substituted alkyl, substituted alkenyl, and substituted aryl.” Analogously, when the term “heteroatom-containing” appears prior to a list of possible heteroatom-containing groups, it is intended that the term apply to every member of that group. For example, the phrase “heteroatom-containing alkyl, alkenyl, and aryl” is to be interpreted as “heteroatom-containing alkyl, heteroatom-containing alkenyl, and heteroatom-containing aryl.”

As used herein, “optionally substituted” indicates that a chemical structure may be optionally substituted with a substituent group, such as defined herein. That is, when a chemical structure includes an atom that is optionally substituted, the atom may or may not include the optional substituent group, and thereby the chemical structure may be considered to be substituted when having a substituent on the atom or unsubstituted when omitting a substituent from the atom. A substituted group, referred to as a “substituent” or “substituent group”, can be coupled (e.g., covalently) to a previously unsubstituted parent structure, wherein one or more hydrogens atoms (or other substituent groups) on the parent structure have been independently replaced by one or more of the substituents. The substituent is a chemical moiety that is added to a base chemical structure, such as a chemical scaffold. As such, a substituted chemical structure may have one or more substituent groups on the parent structure, such as by each substituent group being coupled to an atom of the parent structure. The substituent groups that can be coupled to the parent structure can be any possible substituent group. In examples of the present technology, the substituent groups (e.g., R groups) can be independently selected from an alkyl, —O-alkyl (e.g. —OCH₃, —OC₂H₅, —OC₃H₇, —OC₄H₉, etc.), —S-alkyl (e.g., —SCH₃, —SC₂H₅, —SC₃H₇, —SC₄H₉, etc.), —NR′R″, —OH, —SH, —CN, —NO₂, or a halogen, wherein R′ and R″ are independently H or an optionally substituted alkyl. Wherever a substituent is described as “optionally substituted,” that substituent can also be optionally substituted with the above substituents.

The term “alkyl” or “aliphatic” as used herein refers to a branched or unbranched saturated hydrocarbon group typically although not necessarily containing 1 to about 24 carbon atoms, such as methyl, ethyl, n-propyl, isopropyl, n-butyl, isobutyl, t-butyl, octyl, decyl, and the like, as well as cycloalkyl groups such as cyclopentyl, cyclohexyl, and the like. Generally, although again not necessarily, alkyl groups herein contain 1 to about 18 carbon atoms, or 1 to about 12 carbon atoms. The term “lower alkyl” intends an alkyl group of 1 to 6 carbon atoms. Substituents identified as “C₁-C₆ alkyl” or “lower alkyl” contains 1 to 3 carbon atoms, and such substituents contain 1 or 2 carbon atoms (i.e., methyl and ethyl). “Substituted alkyl” refers to alkyl substituted with one or more substituent groups, and the terms “heteroatom-containing alkyl” and “heteroalkyl” refer to alkyl in which at least one carbon atom is replaced with a heteroatom, as described in further detail infra. If not otherwise indicated, the terms “alkyl” and “lower alkyl” include linear, branched, cyclic, unsubstituted, substituted, and/or heteroatom-containing alkyl or lower alkyl, respectively.

The terms “alkenyl” as used herein refers to a linear, branched or cyclic hydrocarbon group of 2 to about 24 carbon atoms containing at least one double bond, such as ethenyl, n-propenyl, isopropenyl, n-butenyl, isobutenyl, octenyl, decenyl, tetradecenyl, hexadecenyl, eicosenyl, tetracosenyl, and the like. Generally, although again not necessarily, alkenyl groups herein contain 2 to about 18 carbon atoms, or 2 to 12 carbon atoms. The term “lower alkenyl” intends an alkenyl group of 2 to 6 carbon atoms, and the specific term “cycloalkenyl” intends a cyclic alkenyl group, or having 5 to 8 carbon atoms. The term “substituted alkenyl” refers to alkenyl substituted with one or more substituent groups, and the terms “heteroatom-containing alkenyl” and “heteroalkenyl” refer to alkenyl in which at least one carbon atom is replaced with a heteroatom. If not otherwise indicated, the terms “alkenyl” and “lower alkenyl” include linear, branched, cyclic, unsubstituted, substituted, and/or heteroatom-containing alkenyl and lower alkenyl, respectively.

The term “alkynyl” as used herein refers to a linear or branched hydrocarbon group of 2 to 24 carbon atoms containing at least one triple bond, such as ethynyl, n-propynyl, and the like. Generally, although again not necessarily, alkynyl groups herein contain 2 to about 18 carbon atoms, or 2 to 12 carbon atoms. The term “lower alkynyl” intends an alkynyl group of 2 to 6 carbon atoms. The term “substituted alkynyl” refers to alkynyl substituted with one or more substituent groups, and the terms “heteroatom-containing alkynyl” and “heteroalkynyl” refer to alkynyl in which at least one carbon atom is replaced with a heteroatom. If not otherwise indicated, the terms “alkynyl” and “lower alkynyl” include linear, branched, unsubstituted, substituted, and/or heteroatom-containing alkynyl and lower alkynyl, respectively.

The term “alkoxy” as used herein intends an alkyl group bound through a single, terminal ether linkage; that is, an “alkoxy” group may be represented as —O-alkyl where alkyl is as defined above. A “lower alkoxy” group intends an alkoxy group containing 1 to 6 carbon atoms, and includes, for example, methoxy, ethoxy, n-propoxy, isopropoxy, t-butyloxy, etc. Substituents identified as “C₁-C₆ alkoxy” or “lower alkoxy” herein contain 1 to 3 carbon atoms, and such substituents contain 1 or 2 carbon atoms (i.e., methoxy and ethoxy).

The term “aryl” as used herein, and unless otherwise specified, refers to an aromatic substituent containing a single aromatic ring or multiple aromatic rings that are fused together, directly linked, or indirectly linked (such that the different aromatic rings are bound to a common group such as a methylene or ethylene moiety). Examples of aryl groups contain 5 to 20 carbon atoms, and aryl groups contain 5 to 14 carbon atoms. Exemplary aryl groups contain one aromatic ring or two fused or linked aromatic rings, e.g., phenyl, naphthyl, biphenyl, diphenylether, diphenylamine, benzophenone, and the like. “Substituted aryl” refers to an aryl moiety substituted with one or more substituent groups, and the terms “heteroatom-containing aryl” and “heteroaryl” refer to aryl substituent, in which at least one carbon atom is replaced with a heteroatom, as will be described in further detail infra. If not otherwise indicated, the term “aryl” includes unsubstituted, substituted, and/or heteroatom-containing aromatic substituents.

The term “aryloxy” as used herein refers to an aryl group bound through a single, terminal ether linkage, wherein “aryl” is as defined above. An “aryloxy” group may be represented as —O-aryl where aryl is as defined above. Examples of aryloxy groups contain 5 to 20 carbon atoms, and aryloxy groups contain 5 to 14 carbon atoms. Examples of aryloxy groups include, without limitation, phenoxy, o-halo-phenoxy, m-halo-phenoxy, p-halo-phenoxy, o-methoxy-phenoxy, m-methoxy-phenoxy, p-methoxy-phenoxy, 2,4-dimethoxy-phenoxy, 3,4,5-trimethoxy-phenoxy, and the like.

The term “alkaryl” refers to an aryl group with an alkyl substituent, and the term “aralkyl” refers to an alkyl group with an aryl substituent, wherein “aryl” and “alkyl” are as defined above. Examples of aralkyl groups contain 6 to 24 carbon atoms, and aralkyl groups contain 6 to 16 carbon atoms. Examples of aralkyl groups include, without limitation, benzyl, 2-phenyl-ethyl, 3-phenyl-propyl, 4-phenyl-butyl, 5-phenyl-pentyl, 4-phenylcyclohexyl, 4-benzylcyclohexyl, 4-phenylcyclohexylmethyl, 4-benzylcyclohexylmethyl, and the like. Alkaryl groups include, for example, p-methylphenyl, 2,4-dimethylphenyl, p-cyclohexylphenyl, 2,7-dimethyinaphthyl, 7-cyclooctylnaphthyl, 3-ethyl-cyclopenta-1,4-diene, and the like.

The term “cyclic” refers to alicyclic or aromatic substituents that may or may not be substituted and/or heteroatom containing, and that may be monocyclic, bicyclic, or polycyclic.

The terms “halo” and “halogen” are used in the conventional sense to refer to a chloro, bromo, and fluoro or iodo substituent.

The term “heteroatom-containing” as in a “heteroatom-containing alkyl group” (also termed a “heteroalkyl” group) or a “heteroatom-containing aryl group” (also termed a “heteroaryl” group) refers to a molecule, linkage or substituent in which one or more carbon atoms are replaced with an atom other than carbon, e.g., nitrogen, oxygen, sulfur, phosphorus or silicon, typically nitrogen, oxygen or sulfur. Similarly, the term “heteroalkyl” refers to an alkyl substituent that is heteroatom-containing, the term “heterocyclic” refers to a cyclic substituent that is heteroatom-containing, the terms “heteroaryl” and heteroaromatic” respectively refer to “aryl” and “aromatic” substituents that are heteroatom-containing, and the like. Examples of heteroalkyl groups include alkoxyaryl, alkylsulfanyl-substituted alkyl, N-alkylated amino alkyl, and the like. Examples of heteroaryl substituents include pyrrolyl, pyrrolidinyl, pyridinyl, quinolinyl, indolyl, pyrimidinyl, imidazolyl, 1,2,4-triazolyl, tetrazolyl, etc., and examples of heteroatom-containing alicyclic groups are pyrrolidino, morpholino, piperazino, piperidino, etc.

The term “hydrocarbyl” refers to univalent hydrocarbyl radicals containing 1 to about 30 carbon atoms, or 1 to about 24 carbon atoms, or 1 to about 18 carbon atoms, or about 1 to 12 carbon atoms, including linear, branched, cyclic, saturated, and unsaturated species, such as alkyl groups, alkenyl groups, aryl groups, and the like. “Substituted hydrocarbyl” refers to hydrocarbyl substituted with one or more substituent groups, and the term “heteroatom-containing hydrocarbyl” refers to hydrocarbyl in which at least one carbon atom is replaced with a heteroatom. Unless otherwise indicated, the term “hydrocarbyl” is to be interpreted as including substituted and/or heteroatom-containing hydrocarbyl moieties.

All other chemistry terms are defined as known in the art.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only and is not intended to be limiting.

In one embodiment, the present methods can include aspects performed on or by the control of a computing system. As such, the computing system can include a non-transient memory device that has the computer-executable instructions for causing reaction equipment for performing the method described herein. The computer-executable instructions can be part of a computer program product that includes one or more algorithms for performing any of the methods of any of the claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

All references recited herein are incorporated herein by specific reference in their entirety. References: U.S. Pat. Nos. 9,902,874 and 9,790,640.

1. A method for treating a textile to inhibit wicking and/or provide durable water repellency, comprising:
applying a precursor coating composition to at least one surface of a textile; and
curing the precursor coating composition under ambient atmospheric pressure to the at least one surface of the textile to form a hydrophobic coating on the textile, wherein:
the precursor coating composition and hydrophobic coating are fluorine free;
the precursor coating composition and hydrophobic coating are water free; and
the precursor coating composition includes:
A. a first chemical moiety having a Si—H group;
B. a second chemical moiety having an alkene group; and
C. a metallic catalyst that causes a hydrosilylation reaction between the Si—H group and alkene group to link the first chemical moiety to the second chemical moiety, wherein the first chemical moiety and second chemical moiety are on separate chemicals or on a common chemical.

2. The method of claim 1, further comprising preparing the precursor coating composition by:
preparing a first precursor composition having one of the first chemical moiety or the second chemical moiety; and
combining the first precursor composition with a second precursor composition that has the other of the first chemical moiety or second chemical moiety.

3. The method of claim 1, further comprising preparing the precursor coating composition by:
preparing a first precursor composition having the first chemical moiety;
preparing a second precursor composition having the second moiety and the metallic catalyst; and
combining the first precursor composition with a second precursor composition into a curable mixture.

4. The method of claim 1, further comprising preparing the precursor coating composition by:
preparing a polymeric precursor composition having a bifunctional polymer with first monomers having the first chemical moieties and second monomers having the second chemical moieties.

5. The method of claim 1, further comprising preparing the precursor coating composition by introducing the metallic catalyst to:
a first precursor composition;
a second precursor composition;
a curable mixture of the first precursor composition and second precursor composition; or
a polymeric precursor composition with the bifunctional polymer.

6. The method of claim 1, further comprising applying the precursor coating composition to the at least one surface of the textile after forming the precursor coating composition,
wherein the applying of the precursor coating composition to the at least one surface of the textile is within a time period after forming the precursor coating composition, wherein the time period is 1 hour or less after the forming.

7. The method of claim 1, wherein the curing is at one of:
ambient temperature of 20° C.-25° C.; or
an elevated temperature over 25° C. that is below the melting point of the cured hydrophobic coating.

8. The method of claim 1, wherein the precursor coating composition includes:
a first reagent having the at least one Si—H group;
a second reagent having the at least one alkene group; and
an organometallic catalyst,
wherein:
the first reagent includes silanes, hydrogen siloxanes or polyalkylhydrogensiloxanes; and
the second reagent includes a vinyl group, an olefin, an acrylate silane, an acrylate siloxane, dienes, or polydienes.

9. The method of claim 8, wherein the second reagent also includes at least one of a hydrocarbon group, an acrylate group, a siloxane group, a silane group, or combinations thereof.

10. The method of claim 9, further comprising a third reactant being a vinyl-functionalized siloxane or vinyl-functionalized silicone.

11. The method of claim 1, the precursor coating composition further comprising an inert silicone without a reactive functional group.

12. The method of claim 8, comprising forming the precursor coating composition by:
mixing the second reagent and the third reagent into a first mixture;
adding the organometallic catalyst to the first mixture; and
mixing the first reagent with the first mixture to form the precursor coating composition.

13. The method of claim 8, further comprising forming the precursor coating composition by mixing a ratio of the first reagent to the second reagent, wherein the ratio ranges from 10: to 1:10.

14. The method of claim 8, further comprising:
combining the first reagent with the second reagent and metal catalyst, wherein:
the first reagent includes the at least one Si—H group, wherein the first reagent is present in a range of about 0.5% to about 99.5% by weight;
the second reagent includes the at least one alkene group and one hydrocarbon group, wherein the second reagent is present in a range of about 0.5% to about 99.5% by weight; and
the metal catalyst is an organometallic compound that catalyzes hydrosilylation between the first reagent and the second reagent to form the hydrophobic coating.

15. The method claim 8, wherein:
one of the first reagent or second reagent is present in a range of about 20% to about 95% by weight, and the other of the first reagent or second reagent is present in a range of about 80% to about 5% by weight; or
one of the first reagent or the second reagent is present in a range of about 1% to about 50% by weight, and the other of the first reagent or second reagent is present in a range of about 99% to about 50% by weight.

16. The method of claim 8, wherein the first reagent and the second reagent are combined in about a 10-to-1 ratio.

17. The method of claim 1, wherein curing the coating material is at atmospheric pressure range of 750-775 mm Hg.

18. The method claim 1, wherein curing the coating material does not include compressing the substrate to remove molecular oxygen from void spaces in the textile.

19. The method claim 1, wherein the textile is a fibrous textile, nonwoven fabric, or filler material having interstitial spaces between intersecting fibers.

20. The method claim 19, wherein the fibrous textile or nonwoven fabric includes knitted, woven, tufted, knotted, matted and/or entangled fibers.

21. The method of claim 1, wherein the textile includes a nylon, nylon blend, polyester, polyester blend, or combinations thereof.

22. The method of claim 1, wherein the precursor coating composition further comprises a plasticizer, stabilizer, lubricant, inhibitor, colorant, and/or non-aqueous solvent.

23. The method of claim 8, wherein:
the first reagent that has the at least one Si—H bond is a silane, alkyl silane, dialkyl silane, alkoxy silane, trialkyl silane, aryl silane, phenyl silane, aryl-alkyl silane, diaryl silane, triaryl silane diaryl alkyl silane, hydrogen siloxane, alkyl hydrogen siloxane copolymer, or hydrogen siloxane copolymer; and
at least one of:
the second reagent includes ethylene; propylene; 2-methylpropene; 1-pentene; 1-hexene; 1-heptene; 1-octene; 1-nonene); 1-decene; butadiene, propylidene, pentadiene, or combinations thereof:
the second reagent includes vinyl acetate; vinyl propionate; vinyl butyrate; vinyl acrylate; vinyl methacrylate; vinyl crotonate; vinyl isobutyrate; vinyl benzoate; vinyl 2-ethylhexanoate; vinyl caproate; or combinations thereof;
the second reagent includes adipate; divinyl succinate; divinyl sebacate; divinyl phthalate; divinyl terephthalate; divinyl maleate; divinyl isophthalate; divinyl methylphosphonate; divinyl carbonate; divinyl ether; or combinations thereof;
vinyl-functionalized siloxanes, vinyl alkyl siloxanes, vinyl phenyl siloxanes, or copolymers thereof;
the second reagent includes olefins selected from ethylene, propylene, butene, isobutylene, pentene, hexene, octene, decene, isoprene, cyclohexene, dicyclopentadiene, and combinations thereof;
the second reagent includes an alkylacryloxyalkyltrialkoxysilane;
the second reagent includes a polydiene selected from polybutadiene, polyisoprene, polychloroprene, polypentanamer, poly(1,2-butadiene), poly(1,4-hexadiene), poly(1,5-cyclooctadiene), or combinations thereof; or
combinations thereof.

24. The method of claim 4, wherein bifunctional polymers include poly(vinylmethoxysiloxane-co-methylhydrosiloxane); poly(vinylethoxysiloxane-co-phenylhydrosiloxane); poly(vinylchlorosiloxane-co-methylhydrosiloxane); poly(vinylmethylsiloxane-co-methylhydrosiloxane); poly(vinylethoxysiloxane-co-phenylhydrosiloxane); poly(vinylmethoxysiloxane-co-methylhydrosiloxane); poly(vinylisopropylsiloxane-co-phenylhydrosiloxane); poly(vinylphenylsiloxane-co-methylhydrosiloxane); poly(vinylphenylsiloxane-co-phenylhydrosiloxane); or combinations thereof.
